(19) United States
(12) Patent Application Publication
(10) Pub. No.: US 2025/0125100 A1
(43) Pub. Date: Apr. 17, 2025

(54) PUSH SWITCH

(71) Applicant: ALPS ALPINE CO., LTD., Tokyo (JP)

(72) Inventor: Hidetaka SATO, Miyagi (JP)

(21) Appl. No.: 18/903,451

(22) Filed: Oct. 1, 2024

(30) Foreign Application Priority Data
Oct. 16, 2023 (JP) 2023-178024
Aug. 1, 2024 (JP) 2024-125981

(51) Int. Cl. H01H 1/20; H01H 5/30; H01H 13/52

(52) U.S. Cl. CPC H01H 1/20; H01H 5/30; H01H 13/52

(57) ABSTRACT

A push switch includes a case having a recess with an open upper portion and a fixed contact inside the recess, a dome shaped movable contact member formed of a metal plate and accommodated inside the recess of the case, and an operation member configured to press the movable contact member, to cause an inversion operation of the movable contact member. The movable contact member has a sidecut shape having both sides of a circular shape forming a pair of linear portions in a top view, and a sidecut ratio represented by (B/A)×100 within a range of 40% to 70%, where A denotes a diameter of the circular shape, and B denotes a distance between the pair of linear portions.

### CROSS-REFERENCE TO RELATED APPLICATIONS

This application is based upon and claims priority to Japanese Patent Applications No. 2023-178024, filed on Oct. 16, 2023, and No. 2024-125981, filed on Aug. 1, 2024, the entire contents of which are incorporated herein by reference.

### BACKGROUND OF THE INVENTION

### 1. Field of the Invention

Certain aspects of the embodiments discussed herein are related to push switches.

### 2. Description of the Related Art

As an example, Japanese Laid-Open Patent Publication No. 2012-64401 discloses a dome shaped movable contact member used in a switch device. The movable contact member has a pair of cutout portions opposing each other at a skirt portion.

However, a problem to be solved in the related art is to reduce collision noise that is generated when a movable contact member collides with a fixed member during an inversion operation. In the related art, although it is possible to reduce the collision noise by reducing an inversion speed of the movable contact member, it may not be possible to provide a good operational feeling to an operator.

### SUMMARY OF THE INVENTION

According to one aspect of the embodiments, a push switch includes a case having a recess with an open upper portion, and a fixed contact inside the recess; a dome shaped movable contact member, formed of a metal plate and accommodated inside the recess of the case; and an operation member configured to press the movable contact member, to cause an inversion operation of the movable contact member, wherein the movable contact member has a sidecut shape having both sides of a circular shape forming a pair of linear portions in a top view, and a sidecut ratio represented by (B/A)×100 within a range of 40% to 70%, where A denotes a diameter of the circular shape, and B denotes a distance between the pair of linear portions.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is an external perspective view of a push switch according to an embodiment;

FIG. 2 is an exploded perspective view of the push switch according to the embodiment;

FIG. 3 is a cross sectional view of the push switch according to the embodiment;

FIG. 4 is a perspective view illustrating a metal inverted dome in a state disposed inside a recess of a case;

FIG. 5 is a plan view illustrating the metal inverted dome in the state disposed inside the recess of the case;

FIG. 6 is a graph illustrating operating load characteristics of the push switch according to the embodiment and a comparative push switch;

FIG. 7 is a graph illustrating a relationship between a sidecut ratio and an inversion speed of the metal inverted dome according to the embodiment;

FIG. 8A is a graph illustrating the inversion speed of the metal inverted dome in the comparative push switch;

FIG. 8B is a graph illustrating the inversion speed of the metal inverted dome in the push switch according to the embodiment;

FIG. 9 is a graph illustrating a relationship between a sidecut ratio of the metal inverted dome and a sound pressure according to the embodiment;

FIG. 10 is a graph illustrating the relationship between the sidecut ratio and a height of a dome shape of the metal inverted dome according to the embodiment; and

FIG. 11 is a plan view illustrating a modification of the case and the metal inverted dome.

### DESCRIPTION OF THE PREFERRED EMBODIMENTS

Hereinafter, embodiments will be described with reference to the drawings. In the following description, for the sake of convenience, a Z-axis direction in the drawings may be regarded as being an up-down (or vertical) direction, a Y-axis direction in the drawings may be regarded as being a left-right direction, and an X-axis direction in the drawings may be regarded as being a front-rear direction. A positive Z-axis direction may be regarded as being an upward direction, a positive Y-axis direction may be regarded as being a rightward direction, and a positive X-axis direction may be regarded as being a frontward direction.

### (Overview of Push Switch 100)

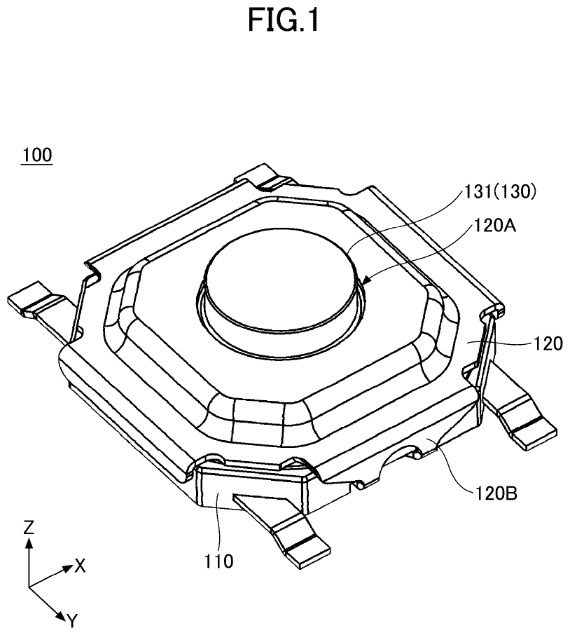

FIG. 1 is an external perspective view of a push switch 100 according to an embodiment. As illustrated in FIG. 1, the push switch 100 has a rectangular parallelepiped shape that is thin in the up-down direction (Z-axis direction) as a whole. The push switch 100 has an approximately square shape in a top view. In the push switch 100, an upper surface 110A of a case 110 is covered with a frame 120. The case 110 accommodates a stem 130 or the like. An operation portion 131 having a convex shape that protrudes upward (in the positive Z-axis direction) is provided at a center portion of the stem 130.

The operation portion 131 of the stem 130 penetrates a circular opening 120A formed in the frame 120, and protrudes upward (in the positive Z-axis direction) from the frame 120. Thus, the push switch 100 can be pressed downward (in the negative Z-axis direction) by the operation portion 131 of the stem 130 when a pressing operation is performed on the operation portion 131, and can be switched from a switch-off state to a switch-on state by the pressing operation.

### (Configuration of Push Switch 100)

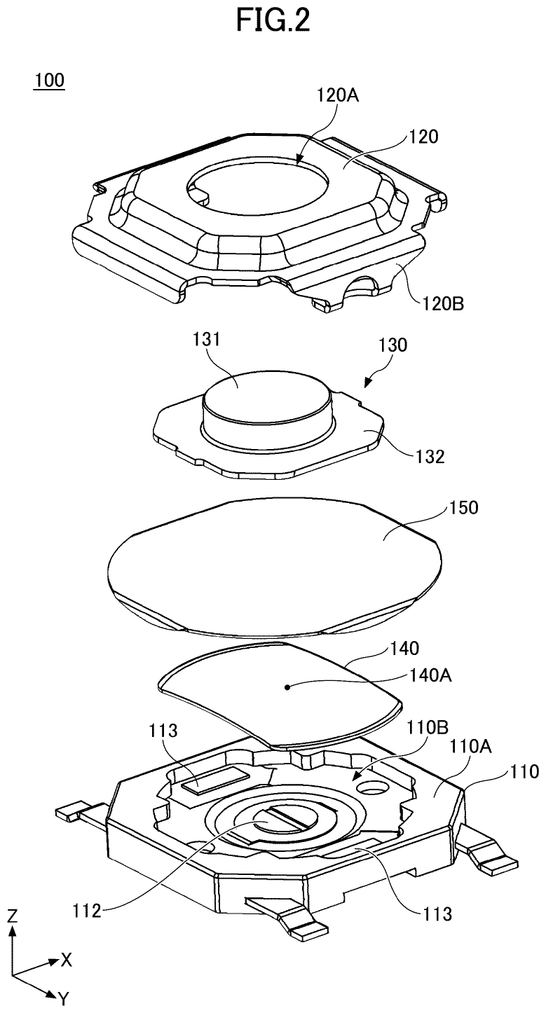

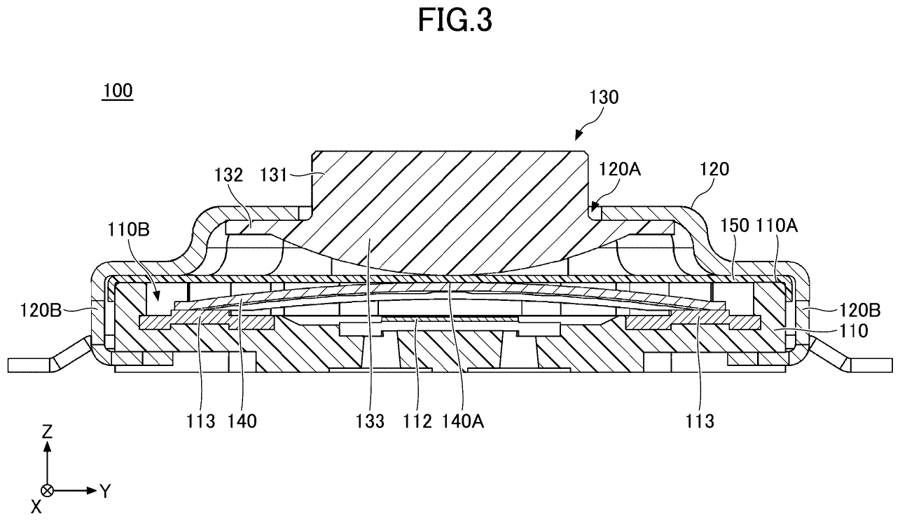

FIG. 2 is an exploded perspective view of the push switch 100 according to the embodiment. FIG. 3 is a cross sectional view of the push switch 100 according to the embodiment. As illustrated in FIG. 2 and FIG. 3, the push switch 100 includes the case 110, a metal inverted dome 140, an insulator 150, an elastic member 160, the stem 130, and the frame 120 in this order from the lower side (negative Z-axis direction side) in the drawings.

The case 110 is a container-shaped member that is thin in the up-down direction (Z-axis direction). The case 110 has an approximately square shape in the top view. The case 110 has a recess 110B that is recessed downward from the upper surface 110A, and the recess 110B has an open upper portion. The metal inverted dome 140 is accommodated inside the recess 110B. For example, the case 110 is formed by insert molding, using a relatively hard insulating material (for example, a hard resin or the like).

A central fixed contact 112 and a pair of left and right peripheral fixed contacts 113 are provided on an inner bottom surface of the recess 110B of the case 110. The central fixed contact 112 is provided at a center of the inner bottom surface of the recess 110B. The pair of left and right peripheral fixed contacts 113 are provided at left and right end portions of the inner bottom surface of the recess 110B, respectively. The central fixed contact 112 and the pair of left and right peripheral fixed contacts 113 are formed using a conductive material (for example, a metal material).

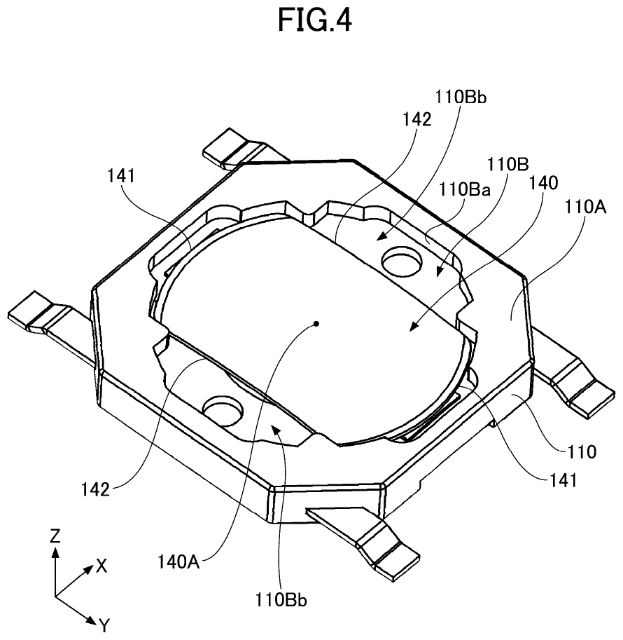

As illustrated in FIG. 4, an inner wall 110Ba of the recess 110B of the case 110 is provided generally along an outer edge of the metal inverted dome 140. However, in the inner wall 110Ba of the recess 110B of the case 110, portions opposing a pair of linear portions 142 of the metal inverted dome 140 are provided at positions separated from the linear portions 142 in the X-axis direction. Thus, the recess 110B of the case 110 has a gap 110Bb formed between each of the pair of linear portions 142 of the metal inverted dome 140 and the inner wall 110Ba.

Hence, in the push switch 100 according to the embodiment, each of the pair of linear portions 142 of the metal inverted dome 140 is disposed so as not to become adjacent to (that is, maintains a distance from) the inner wall 110Ba of the recess 110B of the case 110. For this reason, the push switch 100 according to the embodiment can prevent a movable range of the insulator 150 from becoming limited, and can thus prevent the operational feeling from becoming affected by a limited movable range of the insulator 150.

The metal inverted dome 140 is an example of a “movable contact member”. The metal inverted dome 140 is a thin plate member formed of a metal plate, and has a dome shape that is convex upward (in the positive Z-axis direction) with a top portion 140A portion at a center portion thereof. For example, the metal inverted dome 140 is formed into the dome shape by pressing the metal plate.

The metal inverted dome 140 is accommodated inside the recess 110B of the case 110, and is disposed on the inner bottom surface of the recess 110B. The metal inverted dome 140 is placed on the inner bottom surface of the recess 110B of the case 110, such that an outer peripheral edge portion of the metal inverted dome 510 makes contact with each of the pair of left and right peripheral fixed contacts 113.

The metal inverted dome 140 is a so-called “snap dome” or “tactile dome” type spring. When a pressing operation is performed by the operation portion 131 of the stem 130, the top portion 140A is pressed downward by a pressing portion 133 of the stem 130. Further, when a predetermined operating load is exceeded, the top portion 140A is rapidly and elastically deformed (inversion operation) into a concave shape. Accordingly, the metal inverted dome 140 makes contact with the central fixed contact 112 at a back side of the top portion 140A, and is electrically connected to the central fixed contact 112. As a result, the metal inverted dome 140 can electrically connect the central fixed contact 112 and the peripheral fixed contact 113 to each other via the metal inverted dome 140. When the pressing operation by the operation portion 131 of the stem 130 is released, the metal inverted dome 140 returns to the original convex shape due to an elastic force thereof.

The insulator 150 is an example of a “protective sheet”, and is a thin sheet member disposed on the upper surface 110A of the case 110. The insulator 150 is formed using a resin material, such as polyethylene terephthalate (PET) or the like. The insulator 150 has an approximately square shape in the top view, similar to the case 110. The insulator 150 is bonded to the upper surface 110A of the case 110 by an arbitrary bonding means (for example, thermal welding, laser welding, adhesive, or the like) in a state where the insulator 150 covers the upper surface 110A of the case 110. The insulator 150 seals the recess 110B by closing the upper opening of the recess 110B of the case 110.

The stem 130 is an example of an “operation member”, and is pressed downward by a pressing operation of an operator. For example, the stem 130 is formed using a relatively hard insulating material (for example, a hard resin or the like). The stem 130 includes an operation portion 131, a support portion 132, and a pressing portion 133.

The operation portion 131 is provided at a center of the stem 130, has a cylindrical shape protruding upward from the support portion 132. The operation portion 131 is a portion on which the pressing operation is performed by the operator.

The support portion 132 is a horizontal flat plate portion provided around the operation portion 131. The support portion 132 is provided integrally with the operation portion 131, and supports the operation portion 131. The support portion 132 has an approximately square shape in the top view.

The pressing portion 133 is a dome shaped portion provided to protrude downward, at a center portion of the bottom surface of the stem 130. The pressing portion 133 is a portion that moves downward and presses the top portion 140A of the metal inverted dome 140 when the pressing operation is performed by the operation portion 131 of the stem 130.

The stem 130 is disposed between the frame 120 and the insulator 150 in a state where the operation portion 131 penetrates the circular opening 120A of the frame 120 and a top portion of the pressing portion 133 makes contact with the top portion 140A of the metal inverted dome 140 via the insulator 150.

The frame 120 is a flat plate member formed of a metal. The frame 120 is fixedly attached to the upper surface 110A of the case 110 in a state where the support portion 132 of the stem 130 is pressed from above, to thereby support the stem 130 disposed above the insulator 150.

The frame 120 is formed by processing a metal plate by a method such as pressing or the like, for example. In the top view, the circular opening 120A is formed at the center of the frame 120, to allow the operation portion 131 of the stem 130 to protrude upward. In addition, a hook 120B hanging downward is provided on each of a pair of left and right sides of the outer peripheral edge of the frame 120. The frame 120 is fixed to the case 110 by each of the pair of hooks 120B engaging a side surface and a bottom surface of the case 110.

### (Operation of Push Switch 100)

When the pressing operation is not performed by the operation portion 131 of the stem 130 in the push switch 100 according to the embodiment, the metal inverted dome 140 is in an initial state where the metal inverted dome 140 is convex upward. For this reason, the metal inverted dome 140 makes contact with the peripheral fixed contact 113, but does not make contact with the central fixed contact 112. That is, the peripheral fixed contact 113 and the central fixed contact 112 are not electrically connected to each other. Hence, the push switch 100 according to the embodiment is in the switch-off state when the pressing operation is not performed by the operation portion 131 of the stem 130.

When the pressing operation is performed by the operation portion 131 of the stem 130 in the push switch 100 according to the embodiment, the pressing portion 133 of the stem 130 presses the top portion 140A of the metal inverted dome 140, to elastically deform the metal inverted dome 140.

Further, when the operating load of the pressing operation by the operation portion 131 of the stem 130 exceeds a predetermined threshold value (that is, when a stroke quantity of the stem 130 exceeds a top stroke quantity) in the push switch 100 according to the embodiment, the top portion 140A of the metal inverted dome 140 is elastically deformed (inversion operation) into the concave shape. Thus, the stroke quantity of the stem 130 becomes a bottom stroke quantity, and the metal inverted dome 140 is electrically connected to the central fixed contact 112 by the portion of the metal inverted dome 140 on the back side of the top portion 140A making contact with the central fixed contact 112.

As a result, the push switch 100 according to the embodiment assumes the switch-on state because the central fixed contact 112 and the peripheral fixed contact 113 are electrically connected to each other via the metal inverted dome 140. In this state, the push switch 100 according to the embodiment can provide a click feeling with respect to the pressing operation by the pressing portion 133 of the stem 130, due to the inversion operation of the metal inverted dome 140. Accordingly, the push switch 100 according to the embodiment enables the operator to tactually grasp (that is, perceive through touch) that the switch is switched to the switch-on state. In the push switch 100 according to the embodiment, when the pressing operation by the pressing portion 133 of the stem 130 is released, the metal inverted dome 140 returns to the original convex shape due to the elastic force thereof. As a result, the push switch 100 according to the embodiment returns to the switch-off state.

### (Shape of Metal Inverted Dome 140)

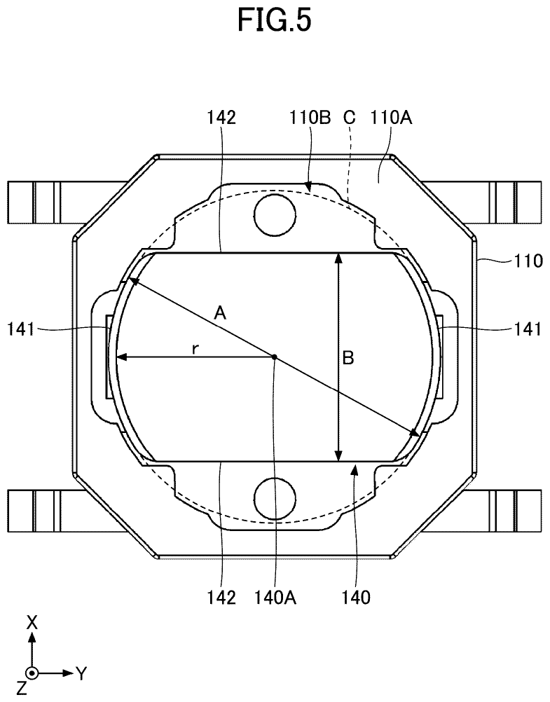

FIG. 4 is a perspective view illustrating the metal inverted dome 140 in a state disposed in the recess 110B of the case 110. FIG. 5 is a plan view illustrating the metal inverted dome 140 in a state disposed in the recess 110B of the case 110.

The metal inverted dome 140 has a sidecut shape having both sides of a circular shape C forming a pair of linear portions in the top view. Specifically, the metal inverted dome 140 has a pair of curved portions 141 along a circumference of the circular shape C, and a pair of linear portions 142 parallel to each other. The circular shape C is a circle concentric to the center (top portion 140A) of the metal inverted dome 140 and having a predetermined radius r.

In the metal inverted dome 140, the pair of curved portions 141 are provided at both ends in the right-left direction (Y-axis direction). The curved portion 141 on the left side (the negative side of the Y axis) is a curved portion having a radius of curvature of equal to the radius r, and connects left end portions of the pair of linear portions 142. The curved portion 141 on the right side (the positive side of the Y axis) is a curved portion having a radius of curvature of equal to the radius r, and connects right end portions of the pair of linear portions 142.

In the metal inverted dome 140, the pair of linear portions 142 are provided at both end portions in the front-rear direction (X-axis direction). Each linear portion 142 of the pair of linear portions 142 extends linearly in the left-right direction (Y-axis direction).

For example, the metal inverted dome 140 is formed to the shape having the pair of curved portions 141 and the pair of linear portions 142 by linearly cutting both sides (portions that become the pair of linear portions 142) of a dome shaped metal member having a circular shape with the radius r in the top view.

As illustrated in FIG. 5, a diameter A of the circular shape C (that is, a distance between the pair of curved portions 141), and a distance B between the pair of linear portions 142 are set such that the metal inverted dome 140 has the sidecut shape having both sides of the circular shape C forming the pair of linear portions 142 in the top view, and a sidecut ratio represented by (B/A)×100 falls within a range of 40% to 70%. This range of the sidecut ratio is a preferable range obtained by the present inventor through simulation or the like.

Accordingly, the push switch 100 according to the embodiment can provide the operator with the same operational feeling (that is, a good operational feeling) as compared with a push switch according to a comparative example (hereinafter referred to as a “comparative push switch”) using a metal inverted dome having a circular shape in the top view (that is, a metal inverted dome without the sidecut), and can also reduce collision noise (that is, operation noise) between the metal inverted dome 140 and the central fixed contact 112 by reducing an inversion speed of the metal inverted dome 140.

Further, the metal inverted dome 140 more preferably has the sidecut ratio in a range of 60% to 70%. This is because the higher the sidecut ratio, the closer the metal inverted dome 140 becomes to a dome shape, and the easier it becomes to provide the operator with an operational feeling equivalent to that of the metal inverted dome without the sidecut.

### Comparative Example of Operation Load Characteristics

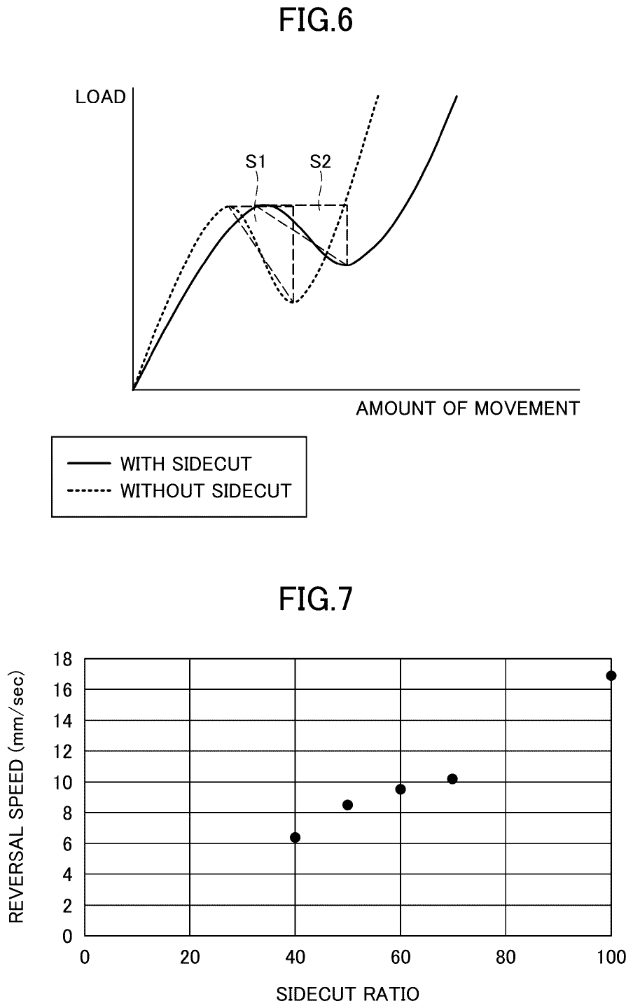

FIG. 6 is a graph illustrating operating load characteristics of the push switch 100 according to the embodiment and the comparative push switch. In the graph illustrated in FIG. 6, a solid line indicates the operating load characteristics of the push switch 100 according to the embodiment using the metal inverted dome 140 having the sidecut shape, and a dotted line indicates the operating load characteristics of the comparative push switch using the circular metal inverted dome without the sidecut.

As illustrated in FIG. 6, in the push switch 100 according to the embodiment, the amount of movement from a top load to a bottom load during the inversion operation of the metal inverted dome 140 is smaller than that of the comparative push switch.

In addition, as illustrated in FIG. 6, in the push switch 100 according to the embodiment, a variation of load from the top load to the bottom load during the inversion operation of the metal inverted dome 140 is smaller than that of the comparative push switch.

For this reason, the push switch 100 according to the embodiment can reduce the collision noise (that is, the operation noise) between the metal inverted dome 140 and the central fixed contact 112, by reducing the inversion speed of the metal inverted dome 140 compared to the comparative push switch.

Triangular regions S1 and S2 illustrated in FIG. 6 contribute to the operational feeling. Areas of the regions S1 and S2 represent an inversion operation quantity of the metal inverted dome for the comparative switch and an inversion operation quantity of the metal inverted dome 140 for the push switch 100 according to the embodiment, respectively. The areas of the regions S1 and S2 can be calculated from V₁× Vₜ× ½, where V₁ denotes the variation in the operating load during the inversion operation of the metal inverted dome, and Vₜ denotes the variation in the top portion in the inversion operation of the metal inverted dome.

As illustrated in FIG. 6, the area of the region S2 of the push switch 100 according to the embodiment is equal to the area of the region S1 of the comparative push switch. This means that the push switch 100 according to the embodiment can provide the operator with the same operational feeling (that is, a good operational feeling) as compared with the comparative push switch.

In other words, in the push switch 100 according to the embodiment, the inversion operation quantity of the metal inverted dome 140 having the sidecut shape can be the same as that of the metal inverted dome not having sidecut shape.

### (Relationship Between Sidecut Ratio and Inversion Speed of Metal Inverted Dome 140)

FIG. 7 is a graph illustrating a relationship between the sidecut ratio and the inversion speed of the metal inverted dome 140 according to the embodiment. The graph illustrated in FIG. 7 illustrates measurement results of the inversion speed of the metal inverted dome 140 for cases where the sidecut ratio of the metal inverted dome 140 is set to 40%, 50%, 60%, 70%, and 100%.

As illustrated in FIG. 7, it was found that the larger the sidecut ratio of the metal inverted dome 140 becomes, the higher the inversion speed of the metal inverted dome 140 becomes. In particular, as illustrated in FIG. 7, it was found that by setting the sidecut ratio of the metal inverted dome 140 within a range of 40% to 70%, the inversion speed of the metal inverted dome 140 can be greatly reduced compared to a case where the sidecut ratio of the metal inverted dome 140 is set to 100% (that is, the case where the metal inverted dome does not have the sidecut shape).

### Comparative Example of Inversion Speed

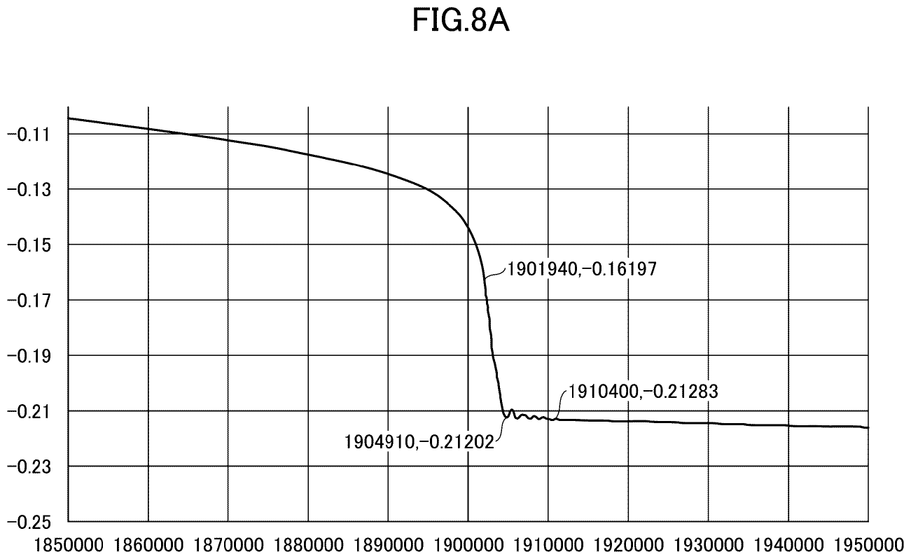

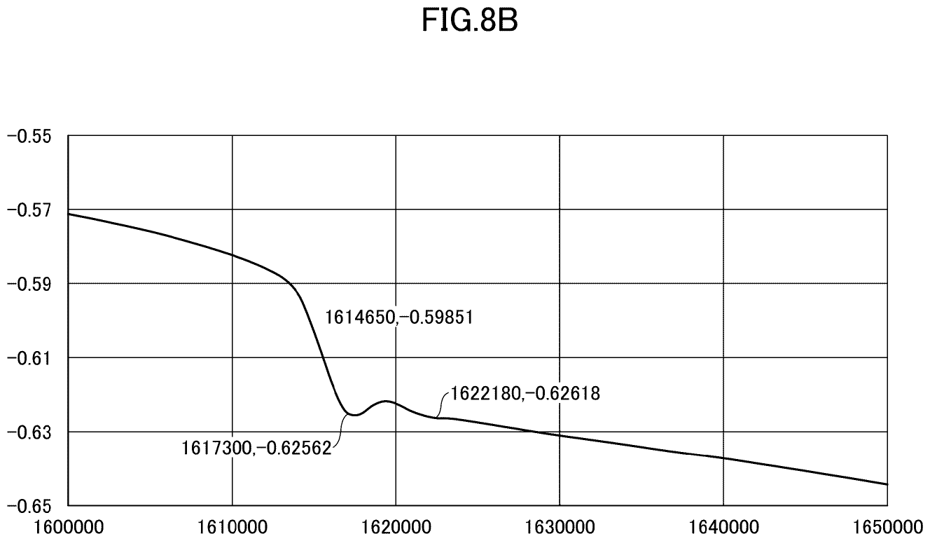

FIG. 8A is a graph illustrating the inversion speed of a metal inverted dome of the comparative push switch. FIG. 8B is a graph illustrating the inversion speed of the metal inverted dome 140 of the push switch 100 according to the embodiment. In the graphs illustrated in FIG. 8A and FIG. 8B, the abscissa indicates the time [s], and the ordinate indicates the amount of movement [mm] of the top portion of the metal inverted dome.

As illustrated in FIG. 8A and FIG. 8B, in the push switch 100 according to the embodiment, the metal inverted dome 140 has the sidecut shape, and thus, the amount of movement of the top portion 140A of the metal inverted dome 140 during the inversion operation of the metal inverted dome 140 is small and the time required for the inversion operation is long, compared to those of the comparative push switch. That is, in the push switch 100 according to the embodiment, the inversion speed of the metal inverted dome 140 is lower than that of the comparative push switch.

For this reason, the push switch 100 according to the embodiment can reduce the collision noise (that is, the operation noise) between the metal inverted dome 140 and the central fixed contact 112, compared to the comparative push switch.

### (Relationship Between Sidecut Ratio of Metal Inverted Dome 140 and Sound Pressure)

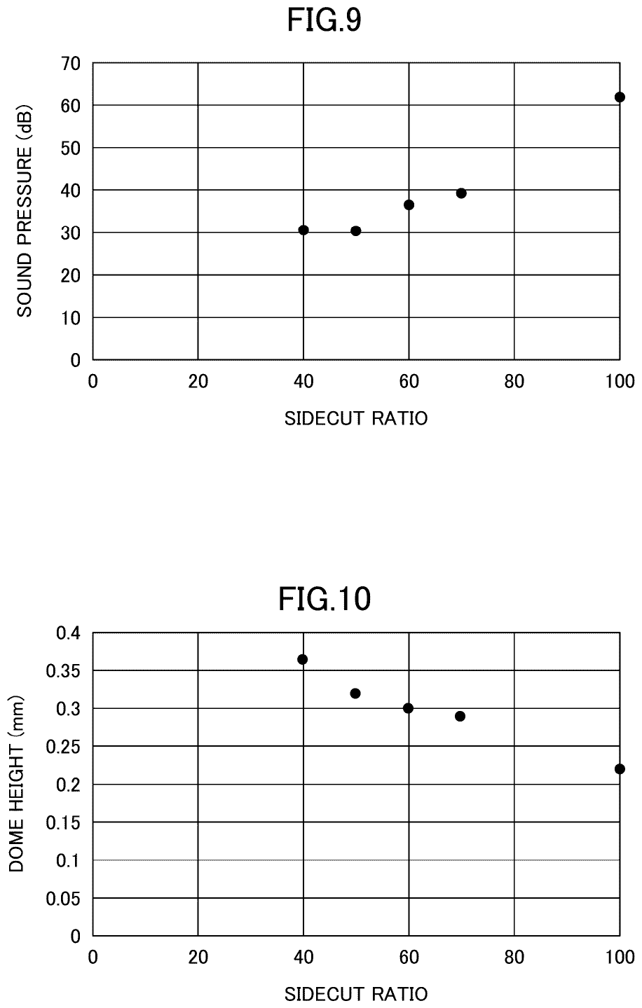

FIG. 9 is a graph illustrating a relationship between the sidecut ratio and a sound pressure of the metal inverted dome 140 according to the embodiment. The graph illustrated in FIG. 9 illustrates measurement results of the sound pressure of the collision noise of the metal inverted dome 140 with the central fixed contact 112 for cases where the sidecut ratio of the metal inverted dome 140 is set to 40%, 50%, 60%, 70%, and 100%.

As illustrated in FIG. 9, it was found that the sound pressure of the collision noise of the metal inverted dome 140 with the central fixed contact 112 increases as the sidecut ratio of the metal inverted dome 140 increases. In particular, as illustrated in FIG. 9, it was found that by setting the sidecut ratio of the metal inverted dome 140 within a range of 40% to 70%, the sound pressure of the collision noise of the metal inverted dome 140 with the central fixed contact 112 can be greatly reduced compared to the case where the sidecut ratio of the metal inverted dome 140 is set to 100% (that is, the case where the metal inverted dome does not have the sidecut shape).

### (Relationship Between Sidecut Ratio of Metal Inverted Dome 140 and Height of Dome Shape)

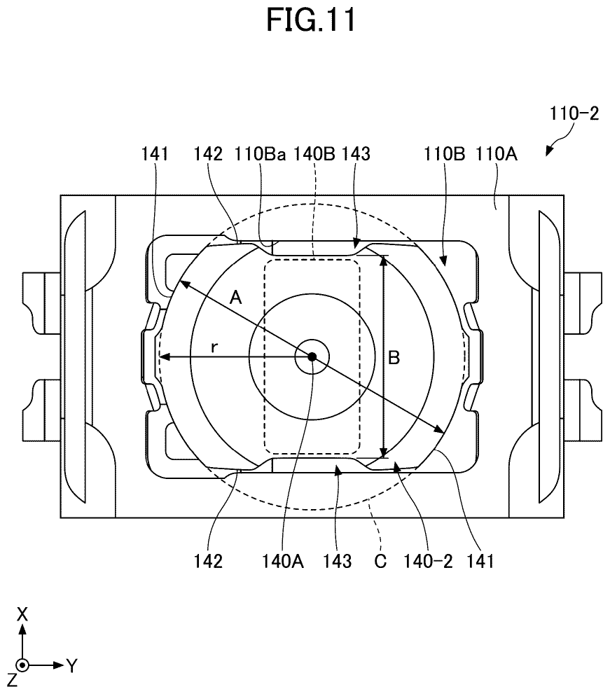

FIG. 10 is a graph illustrating a relationship between the sidecut ratio and a height of the dome shape of the metal inverted dome 140 according to the embodiment. The graph illustrated in FIG. 10 illustrates measurement results of the height of the dome shape required to obtain a constant actuating force of the metal inverted dome 140 for cases where the sidecut ratio of the metal inverted dome 140 is set to 40%, 50%, 60%, 70%, and 100%.

As illustrated in FIG. 10, it was found that, as the sidecut ratio of the metal inverted dome 140 decreases, the height of the dome shape needs to be increased in order to obtain a constant actuating force. In other words, it was found that, even though the metal inverted dome 140 according to the embodiment has the sidecut shape to reduce the collision noise, the metal inverted dome 140 can still obtain an actuating force equivalent to that of a metal inverted dome having no sidecut shape, by setting the height of the dome shape to an appropriate height.

In the push switch 100 according to the embodiment, the diameter of the metal inverted dome 140 is preferably in a range of 3 mm to 8 mm. Thus, the size of the push switch 100 according to the embodiment can be reduced, and the push switch 100 having the reduced size can provide a good operational feeling to the operator by the metal inverted dome 140.

In the push switch 100 according to the embodiment, a thickness of the metal plate of the metal inverted dome 140 is preferably in a range of 25 μm to 80 μm. Thus, in the push switch 100 according to the embodiment, the metal inverted dome 140 can obtain a favorable spring characteristic, and as a result, the metal inverted dome 140 can present a good operational feeling to the operator.

In addition, in the push switch 100 according to the embodiment, a material used for the metal plate of the metal inverted dome 140 is preferably SUS301 or SUS304. Thus, in the push switch 100 according to the embodiment, the metal inverted dome 140 can obtain a favorable spring characteristic, and as a result, the metal inverted dome 140 can present a good operational feeling to the operator.

### (Modification of Case 110 and Metal Inverted Dome 140)

FIG. 11 is a plan view illustrating a modification of the case 110 and the metal inverted dome 140. A case 110-2 illustrated in FIG. 11 is the modification of the case 110. A metal inverted dome 140-2 illustrated in FIG. 11 is the modification of the metal inverted dome 140.

The case 110-2 has an approximately rectangular outer shape with the left-right direction (Y-axis direction) as a longitudinal direction thereof in the top view. The case 110-2 has an approximately rectangular recess 110B having the left-right direction (Y-axis direction) as a longitudinal direction thereof in the top view. The metal inverted dome 140-2 is accommodated inside the recess 110B of the case 110-2.

The metal inverted dome 140-2 has a sidecut shape in which both sides in the front-rear direction (X-axis direction) are linearly cut with respect to the circular shape C in the top view. Specifically, the metal inverted dome 140-2 has a pair of left and right curved portions 141 along the circumference of the circular shape C, and a pair of front and rear linear portions 142 parallel to each other. The circular shape C is a circle concentric to the center (top portion 140A) of the metal inverted dome 140 and having the predetermined radius r.

In the metal inverted dome 140-2, a cutout portion 143 having a shape cut inward is formed in each of the front and rear linear portions 142. Thus, the metal inverted dome 140-2 has a narrow portion 140B in a middle portion in the left-right direction (Y-axis direction). The narrow portion 140B is narrowed in the front-rear direction (X-axis direction), which is perpendicular to the direction in which the pair of linear portions 142 extend.

In the metal inverted dome 140-2, the diameter A and the distance B are set such that the sidecut ratio represented by (B/A)×100 falls within the range of 40% to 70%, similar to the metal inverted dome 140.

However, in a case where the metal inverted dome 140 is used, the sidecut ratio can be calculated by setting a distance between the pair of linear portions 142 to the distance B, but because the metal inverted dome 140-2 has the narrow portion 140B, the sidecut ratio can be calculated by setting a width of the narrow portion 140B to the distance B as illustrated in FIG. 11.

In the case where the push switch 100 includes the metal inverted dome 140-2 having the narrow portion 140B, the operating load characteristics of the push switch 100 is determined not by the distance between the pair of linear portions 142 of the metal inverted dome 140-2 but by the width of the narrow portion 140B of the metal inverted dome 140-2. For this reason, in the case where the push switch 100 includes the metal inverted dome 140-2, the sidecut ratio can be calculated by setting the distance B to the width of the narrow portion 140B.

Accordingly, even when the metal inverted dome 140-2 illustrated in FIG. 11 is provided, the push switch 100 according to the embodiment can provide the operator with the same operational feeling (that is, good operational feeling) as compared with the comparative push switch using the metal inverted dome having the circular shape in top view (that is, the metal inverted dome without the sidecut), and can reduce the collision noise (that is, operation sound) between the metal inverted dome 140-2 and the central fixed contact 112 by reducing the inversion speed of the metal inverted dome 140-2.

Further, the metal inverted dome 140-2 more preferably has the sidecut ratio within the range of 60% to 70%, similar to the metal inverted dome 140. This is because the higher the sidecut ratio becomes, the closer the shape becomes to a dome shape, and the easier it becomes to provide the operator with an operational feeling equivalent to that of the metal inverted dome not having the sidecut.

The metal inverted dome 140-2 is positioned in the front-rear direction (X-axis direction) and in a rotational direction by the pair of front and rear linear portions 142 contacting the inner wall 110Ba of the recess 110B of the case 110-2. On the other hand, the operating load characteristics of the push switch 100 are determined by the width of the narrow portion 140B of the metal inverted dome 140-2. For this reason, in the case where the metal inverted dome 140-2 is used, the push switch 100 can adjust the operating load characteristics of the push switch 100 by varying the shape of the cutout portions 143 of the metal inverted dome 140-2 to adjust the width of the narrow portion 140B without varying the sizes of the metal inverted dome 140-2 and the recess 110B of the case 110-2.

According to the push switch of the embodiments, it is possible to provide a good operational feeling to the operator and to reduce collision noise of a movable contact member.

All examples and conditional language recited herein are intended for pedagogical purposes to aid the reader in understanding the invention and the concepts contributed by the present inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A push switch comprising:
a case having a recess with an open upper portion, and a fixed contact inside the recess;
a dome shaped movable contact member, formed of a metal plate and accommodated inside the recess of the case; and
an operation member configured to press the movable contact member, to cause an inversion operation of the movable contact member,
wherein the movable contact member has a sidecut shape having both sides of a circular shape forming a pair of linear portions in a top view, and a sidecut ratio represented by (B/A)×100 within a range of 40% to 70%, where A denotes a diameter of the circular shape, and B denotes a distance between the pair of linear portions.

2. The push switch as claimed in claim 1, wherein the movable contact member has the sidecut ratio that decreases as a height of the dome shape increases, so that the movable contact member exerts a constant actuating force during the inversion operation.

3. The push switch as claimed in claim 1, wherein an inversion operation amount of the movable contact member represented by V₁×Vₜ×½ is identical between a case where the movable contact member has the sidecut shape and a case where the movable contact member does not have the sidecut shape, where V₁ denotes a variation in an operating load during the inversion operation of the movable contact member, and Vₜ denotes a variation of a top portion of the movable contact member during the inversion operation of the movable contact member.

4. The push switch as claimed in claim 1, wherein the movable contact member has a diameter within a range of 3 mm to 8 mm.

5. The push switch as claimed in claim 1, wherein the metal plate of the movable contact member has a thickness is within a range of 25 μm to 80 μm.

6. The push switch as claimed in claim 1, wherein the metal plate of the movable contact member is formed of a material selected from SUS301 or SUS304.

7. The push switch as claimed in claim 1, wherein the sidecut ratio is within a range of 60% to 70%.

8. The push switch as claimed in claim 1, wherein the recess of the case has a gap at a position opposing each linear portion of the pair of linear portions of the movable contact member.

9. The push switch as claimed in claim 8, further comprising:
a protective sheet covering an upper surface of the case and bonded to the upper surface of the case.

10. The push switch as claimed in claim 1, wherein:
the movable contact member includes a narrow portion having a narrowed width in a direction perpendicular to a direction in which the pair of linear portions extend, by a cutout provided in each of the pair of linear portions, and
the sidecut ratio is represented using the narrowed width of the narrow portion as the distance B between the pair of linear portions.
